(19) United States
(12) Patent Application Publication
(10) Pub. No.: US 2008/0304805 A1
(43) Pub. Date: Dec. 11, 2008

(54) PREPARING AND PRESENTING A PREVIEW OF VIDEO PLACEMENT ADVERTISEMENTS

(76) Inventors: Roy BAHARAV, Studio City, CA (US); Oren SHANI, Petach Tikva (IL)

Correspondence Address: Pearl Cohen Zedek Latzer, LLP, 1500 Broadway, 12th Floor, New York, NY, 10036, US

(21) Appl. No.: 12/133,462

(22) Filed: Jun. 5, 2008

Related U.S. Application Data
(60) Provisional application No. 60/942,212, filed on Jun. 6, 2007.

(51) Int. Cl. G11B 27/00

(52) U.S. Cl. 386/4

(57) ABSTRACT

A method and system for preparing a video advertising insertion clip that utilizes an existing video presentation that currently features and/or will feature virtual product placement. The advertising insertion clip is obtained with minimal additional production resources and overhead in conjunction with a virtual product placement process. By the use of scripts, metadata, and/or equivalent machine-readable instructions or commands, the process can be configured to automatically generate insertion clips for video presentations that are repurposed and/or to be repurposed.

### CROSS-REFERENCE TO RELATED APPLICATIONS

The present application claims benefit of U.S. Provisional Patent Application 60/942,212 filed Jun. 6, 2007, which is incorporated in its entirety by reference herein.

### FIELD OF THE INVENTION

The present invention relates to video advertisements and, more particularly, to a method and system for preparing and presenting a preview of video placement advertisements.

### BACKGROUND OF THE INVENTION

A common mode of displaying advertisements during a video presentation is to insert one or more short advertising clips during the natural breaks of the video presentation; or to display as a separate preview thereof. Insertion can be before the video presentation (“pre-roll”), between scenes of the video presentation (“mid-roll”), after the video presentation (“post-roll”), or separate from the video presentation (“preview”). The terms “advertising insertion clip” and “insertion clip” herein denote any of: pre-roll, mid-roll, post-roll, and preview. Insertion clip advertising displays are sometimes combined as part of a unified advertising campaign. Advertising insertion clips are short and typically range in duration from 15 seconds up to 60 seconds. Many video platforms, including TV and the Internet, are suitable for this mode. On the Internet, most of the clips are relatively short, and a pre-roll is typically preferred by advertisers.

The term “video” herein denotes any visual or audio-visual material or content, and is herein expansively construed to encompass technologies including, but not limited to: cinema, motion pictures, and photography; electronic displays; computer displays; television; video; computer animations and simulations; computer games; and the like. The multiple individual static images of a video are generally denoted as “frames”, and appear in a sequential order predetermined during recording and/or editing. The location of a particular frame in a video can be specified by a number indicating the frame's position in the sequence, or by the time relative to the start of the video at which the frame appears during playback at a predetermined frame rate.

The term “video presentation” herein denotes video matter which is the main interest of the viewers thereof. Non-limiting examples of video presentations include: sporting events; concerts; movies; music videos; television shows; and news programming. A video may be recorded on, and played back from, storage media; and/or may be received as signals or data and played back therefrom. Many video presentations are displayed in repeat showings at different times, and the term “preview” therefore herein denotes an advertising display separate from a video presentation, regardless of whether it appears prior to a particular showing of the video presentation or afterwards. The term “clip” herein denotes any section of a video, whether in real-time or in storage, which is intended to be viewed as a whole unit, including, but not limited to a scene of a video presentation or an advertising insertion.

The trend is toward shorter advertisement insertions, to attain a better hold the viewers' attention, but it is widely felt that even a 15-second advertisement is too long to hold the viewer's attention. Unfortunately, the options for creating such short advertising clips are limited, while the production cost of a short clip does not diminish in proportion to the clip duration, but tends to remain high. Complicating this problem is a trend whereby viewers of Internet videos mute the sound (such as when viewing in the workplace)—for example, many pre-roll insertions rely on sound as important part of the advertising message.

A mode of advertising display intended to supplement or replace pre-roll, mid-roll, and post-roll advertisement insertion is “product placement”, a term which herein denotes the placement of an advertised product to appear within a scene of a video presentation itself, rather than before or after or during the natural breaks. A video presentation or clip thereof featuring a product placement is herein denoted as a “product placement clip”. An advertised product featured in a video presentation in the foregoing manner is herein denoted by the term “placed product”.

The technology of product placement allows products to be placed in either or both of the following ways: (a) physical product placement, whereby a real instance of the placed product is physically present in the setup for a scene during recording of the video presentation; and (b) virtual product placement, whereby an image of the placed product is added to an existing video presentation.

The term “recording” in the context of creating a video herein denotes the rendering of a physical scene into a representation thereof for subsequent reproduction. Recording may be done with video equipment including, but not limited to: photographic motion picture camera equipment; broadcast television camera equipment; closed-circuit television camera equipment; and computer-based camera equipment. The term “recording” is herein expansively construed to include: broadcast, transmission, or live relay (“real time”) of video; and video placed into storage media including, but not limited to: film; data storage; magnetic storage; optical storage; disk; tape; data network and communications network storage; and flash memory or other semiconductor memory storage.

It is noted that virtual product placement may be performed during an editing post-production process on a video presentation in media storage; and also may be performed in real-time on a data stream emanating from a recording of a live event.

The term “pre-placed video” herein denotes a video presentation with physical product placement. The term “post-placed video” herein denotes a video presentation with virtual product placement.

Virtual product placement enables the “repurposing” of a video presentation. The term “repurposing” and related forms herein denote the prior-art modification of a pre-existing video presentation by substituting the image of a new placed product for a previous placed product in the pre-existing video presentation, or a placed product where no placed product previously existed in the video presentation. Repurposing allows the same video presentation to be shown in different market areas, where different products, brands, versions, etc., of a product are being marketed. Repurposing can be done at any time once the original production is available, and can be done by parties other than the producer(s) of the original video presentation.

FIG. 1 is a line illustration of a frame 100 from a prior-art video presentation with product placement. A product 101 is placed within the scene, either via physical product placement or by virtual product placement. FIG. 2 is a line illustration of a frame 200 from a prior-art repurposed version of the video presentation shown in FIG. 1, where an alternative virtually-placed product 201 has been substituted for product 101 in frame 100 of the original video presentation. For example, in one market area, the (fictitious) linguine pasta product branded “Fulmine Linguine” is being marketed, whereas in a different market area (such as in a different country), the (fictitious) linguine pasta product branded “Giuoco Linguine” is being marketed. In the former market area, the video presentation of FIG. 1 would be shown, whereas in the latter market area, the video presentation of FIG. 2 would be shown. Otherwise, the original video presentation and the repurposed video presentation are identical. It is noted that fictitious brand names are used in the examples herein are, and are for purposes of illustration only.

Even when product placement is used in a video presentation, however, it is still desirable to have a related advertising clip of the product that can serve as a pre-roll, mid-roll, post-roll insertion, and/or preview. Currently, however, this requires separate production for the product placement in the video presentation and for the insertion clip(s). Separate production leads to wasteful, duplicated effort, increased production time, and increased cost.

Therefore, it would be highly advantageous to have a method and system whereby both product placement and insertion clips could be produced together through an integrated process that eliminates duplicated effort and reduces production time and cost. This goal is met by the present invention.

### SUMMARY OF THE INVENTION

The present invention is of a method and system for automatic, semi-automatic, or manual composition, preparation, and presentation of, a new advertising insertion clip featuring references to product placement in a video presentation featuring virtual product placement, such that the advertising insertion clip can be used as pre-roll, mid-roll, or post roll with the video presentation, or as a separate preview thereof.

Advantages of the present invention include:

Reducing the need to film short commercial advertisements—product placements in video presentations can be used for automatic production of short advertising insertion clips.

Inherently gives a relevant context to pre-rolls, mid-rolls, and post-rolls displayed with video presentations featuring placed products, thereby solving a bothersome creative challenge.

Reduced costs when a video presentation is repurposed to feature different placed products.

According to embodiments of the present invention, an insertion clip is produced as a by-product of virtual product placement in a video presentation. According to further embodiments of the present invention, the procedure for producing an insertion clip during virtual product placement is automated, by means including a scripting language, so that additional insertion clips featuring different placed products can be easily and quickly produced.

According to embodiments of the present invention, the new advertising insertion clip contains at least one segment of the video presentation featuring a product placement along with a reference to the product placement. Non-limiting examples of references to a product placement include: zoom on the placed product; animations or graphics of the placed product; logo graphics or text related to the placed product; the artwork for the placed virtual product; or any combination thereof. Associated with embodiments of the present invention are opportunities for new models of pricing, business arrangements, reporting, and monetization.

Therefore, according to the present invention there is provided a method for producing a video presentation featuring a placed product and an insertion clip featuring a reference to the placed product, the method including: (a) obtaining a recorded video clip for the video presentation, wherein the recorded video clip includes a plurality of recorded video frames; (b) obtaining virtual product artwork for a product placement; (c) obtaining a placed product reference to the placed product; (d) obtaining an insertion clip pattern for the insertion clip, wherein the insertion clip pattern contains at least one product placement reference template, wherein the product placement reference template contains: (e) at least one placed product video frame container for holding a video presentation frame featuring the product placement; and (f) at least one placed product reference container for holding the placed product reference; (g) identifying at least one frame of the plurality of recorded video frames in the recorded video clip for featuring the product placement; (h) injecting the virtual product artwork into the at least one recorded video frame, to produce the video presentation featuring the product placement; (i) selecting at least one frame of the video presentation featuring the product placement for the insertion clip; and (j) injecting the at least one frame of the video presentation featuring the product placement into the placed product video frame container of the product placement reference template in the insertion clip pattern; and (k) injecting the placed product reference into the placed product reference container of the product placement reference template in the insertion clip pattern; to produce the insertion clip featuring a reference to the placed product.

In addition, according to the present invention there is also provided a method for producing an insertion clip featuring a reference to a placed product from a video presentation featuring a placed product, the method including: (a) obtaining the video presentation featuring the placed product, wherein the video presentation includes a plurality of video presentation frames; (b) obtaining a placed product reference to the placed product; (c) obtaining an insertion clip pattern for the insertion clip, wherein the insertion clip pattern contains at least one product placement reference template, wherein the product placement reference template contains: (d) at least one placed product video frame container for holding a video presentation frame featuring the product placement; and (e) at least one placed product reference container for holding the placed product reference; (f) identifying at least one frame of the plurality of video presentation frames, wherein the at least one frame features the product placement; (g) injecting the at least one frame of the video presentation featuring the product placement into the placed product video frame container of the product placement reference template in the insertion clip pattern; and (h) injecting the placed product reference into the placed product reference container of the product placement reference template in the insertion clip pattern; to produce the insertion clip featuring a reference to the placed product.

### BRIEF DESCRIPTION OF THE DRAWINGS

The invention is herein described, by way of example only, with reference to the accompanying drawings, wherein:

FIG. 1 is a line illustration of a frame from a prior-art video presentation with product placement;

FIG. 2 is a line illustration of a frame from a prior-art repurposed version of the video presentation frame shown in FIG. 1, where an alternative virtually-placed product has been substituted for the product of the original video presentation;

FIG. 3 conceptually illustrates a product placement reference template for an advertising insertion clip according to an embodiment of the present invention;

FIG. 4A shows a frame of an insertion clip produced from the template of FIG. 3 holding a frame of a video presentation with a placed product, according to an embodiment of the present invention;

FIG. 4B shows a frame of an insertion clip produced from the template of FIG. 3 holding a frame of a video presentation with a placed product, subsequent to that of FIG. 4A, with a visual effect and reference to the placed product, as provided by an embodiment of the present invention;

FIG. 5A shows a frame of an insertion clip produced from the template of FIG. 3 holding a frame of a video presentation with an alternate placed product, according to an embodiment of the present invention;

FIG. 5B shows a frame of an insertion clip produced from the template of FIG. 3 holding a frame of a video presentation with the alternate placed product, subsequent to that of FIG. 5A, with a visual effect and reference to the alternate placed product, as provided by an embodiment of the present invention;

FIG. 6A conceptually illustrates a production layout for a video presentation with product placement and an insertion clip according to an embodiment of the present invention;

FIG. 6B conceptually illustrates a production layout for a video presentation with product placement and an insertion clip according to another embodiment of the present invention;

FIG. 7 illustrates an insertion clip pattern according to an embodiment of the present invention;

FIG. 8 is a flowchart of a method for producing a video presentation with product placement and an insertion clip according to an embodiment of the present invention; and

FIG. 9 is a flowchart of a method for producing an insertion clip for a video presentation featuring product placement according to a further embodiment of the present invention.

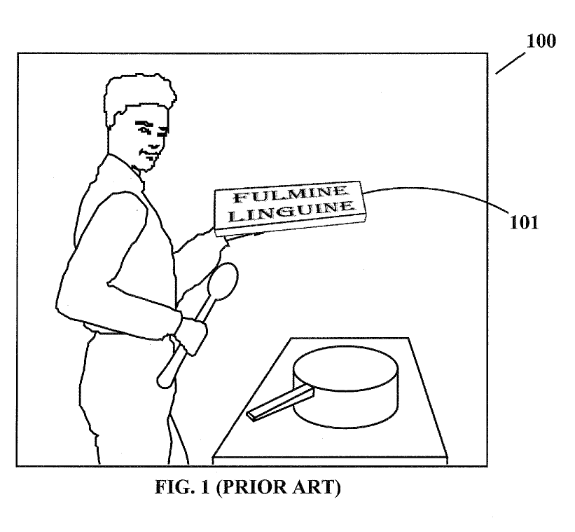

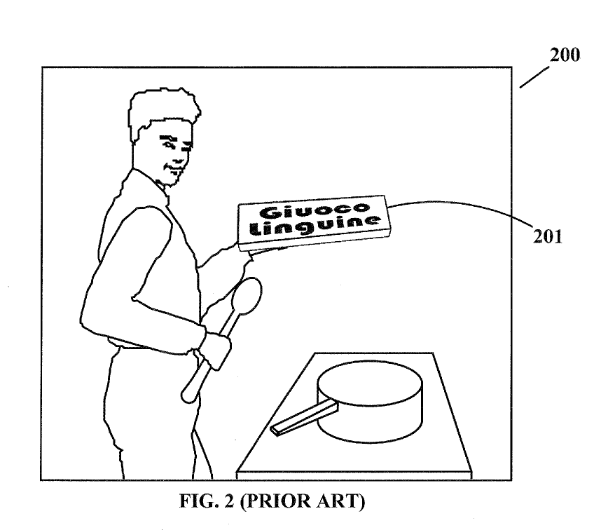

### DESCRIPTION OF THE PREFERRED EMBODIMENTS

The principles and operation of a method and system according to the present invention may be understood with reference to the drawings and the accompanying description. It is noted that, for the purpose of clarity, the drawings are monochrome line illustrations, rather than photographic illustrations, it being understood that in actual practice the appearance of video displays according to the present invention are not limited to monochrome line graphics.

It is also understood that the methods described herein are performed at least in part through the use or “data processing apparatus”, which term denotes without limitation: computers; data processors, devices, and systems; device controllers; computer and data networks; workstations; video and image processing equipment; and similar systems embedded in devices and apparatus with imaging, image-capturing, and/or image display capabilities. In particular, the term “data processing apparatus” is herein expansively construed to encompass a capacity to perform data processing operations which are particular to the fields of image processing and video production.

### Product Placement Reference Templates

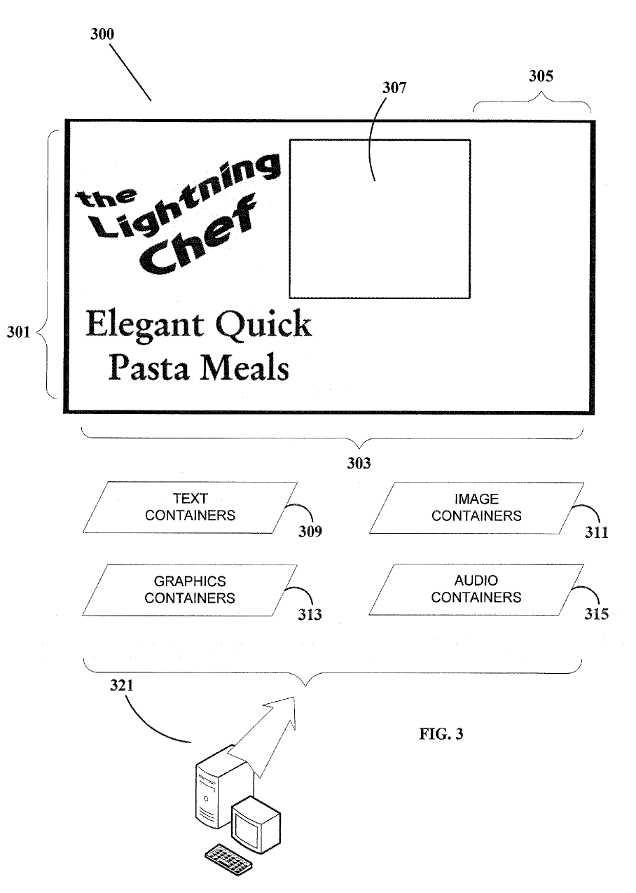

FIG. 3 conceptually illustrates a product placement reference template 300 for an advertising insertion clip according to an embodiment of the present invention. For conciseness, the term “template” is also used herein to denote a product placement reference template, which is a model for creating a video frame for use in an insertion clip according to embodiments of the present invention.

Template 300 includes at least one image container 307 for holding a video image. The attributes of image container 307 may be varied for different video appearances. In a non-limiting embodiment of the present invention, image container 307 holds a portion of a frame. In another embodiment, image container 307 holds an entire video frame. In a further embodiment, image container 307 is scaled to hold an entire video frame or portion thereof in an area smaller than the original video frame. In yet another embodiment, image container 307 is the same size as the original video frame. In an associated embodiment, image container 307 can feature video filters and/or overlays. In still another embodiment, template 300 features multiple image containers (not shown). In certain embodiments of the present invention, a video image placed in image container 307 is a frame of a video presentation; in preferred embodiments, the video presentation frame in image container 307 includes at least one placed product.

Template 300 also includes a reference container 301, for holding a reference to the video presentation and/or the image in image container 307. Additional regions for reference containers include a region 303 and a region 305. Reference container 301 is a text reference to a video presentation with product placement, which in the non-limiting example of FIG. 3 is a television cooking show.

The term “container” herein denotes a data structure or displayed representation thereof for receiving audio-visual data of a video clip. A non-limiting example of a container is a blank rectangle in a video frame for receiving an image that is to be displayed in the region of the container. Containers are sometimes filled with dummy data, such as a color, text, or simple pattern, such that the dummy data acts as a default display in the container region, and is replaced when the container is filled with the actual data.

It is noted that a container's size and position can change from one frame to the next. Typically associated with a container is metadata descriptive of the container and the properties and attributes thereof, both static (the same for all frames) and dynamic (changing from one frame to another).

The nature and use of containers (both 2-dimensional and 3-dimensional) for virtual product placements is disclosed in U.S. Provisional Patent Application 60/942,212 of the present inventor, filed Jun. 6, 2007, which is incorporated by reference herein. As noted above, containers are not limited to images; according to embodiments of the present invention, containers can be specified for text, graphics, animations, visual effects, and audio. It is noted that for video frames, an image container may be self-contained within a template for a single frame (the template for the next frame can hold the next video frame, etc.). The same image (a “still” image), however, may be placed in consecutive templates in consecutive frames. For certain containers such as text, graphics, audio, animations, visual effects, aural effects, etc., the contents of a container may extend over a number of consecutive frames in the final video clip.

Template 300 can be embodied in various forms and formats, including data structures specifying text containers 309, image containers 311, graphics containers 311, and audio containers 315. A template can exist and be manipulated in display format (as is represented in FIG. 3 via template 300) with associated metadata, or strictly as data by data processing equipment and computer programs therefor.

It is noted that in practice, a data copy of a template is typically made, and it is the copy which is modified by the insertion of the actual data. The original template itself remains unmodified for future use. Therefore, it is understood that references herein to templates are intended to also relate to copies of the templates.

Templates may be created via a computer or workstation 321, and can be created and/or modified by editing as part of the production processes described herein.

### Effects

In the previous discussion, it was noted that containers may include effects, and this may be an effect held by a container, or an effect specified by the container's metadata. The term “effect” herein denotes any created audio/visual content or modification of audio/visual content that is introduced to enhance the viewing experience or to attract the viewer's attention, including, but not limited to: visual effects, such as pan, zoom, camera angle; color, intensity, or balance alterations; transitions from one scene to another, such as fade, wipe, dissolve; and aural effects such as incidental music, sound effects; voice and voice over; fade-in, fade-out; echo; and the like.

Insertion Clip Frames from Product Placement Reference Templates

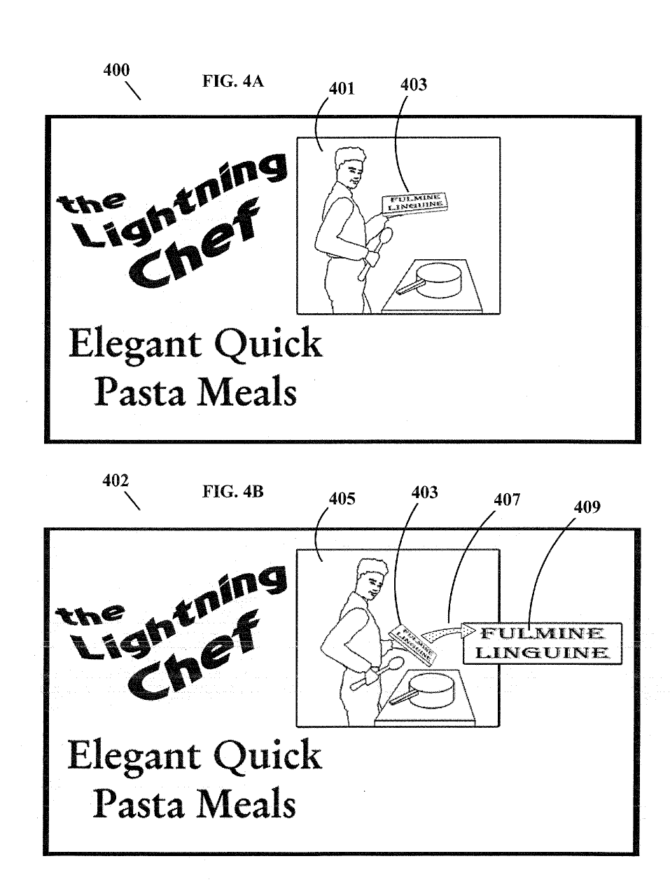

FIG. 4A shows a frame 400 of an insertion clip produced from template 300 (FIG. 3) holding a frame image 401 from a video presentation with a placed product 403, according to an embodiment of the present invention. Frame 400 was produced by injecting frame 401, suitably scaled and positioned as necessary according to the metadata of image container 307. The term “inject” and variants thereof herein denote the placing of data into a container, either in as low-level data into a data structure, or as high-level display representations thereof (such as copying, pasting, etc. of images, text, graphics, and so forth).

FIG. 4B shows a frame 402 of the insertion clip subsequent to frame 400 (FIG. 4A), having a frame image 405 from the video presentation with placed product 403 in image container 307 instead of frame image 401. Placed product 403 may appear visually different. In addition placed product artwork 409 also appears in a reference container, with a visual effect 407. That is, placed product artwork 409 is used as a reference to the placed product in the video presentation. The arrow of visual effect 407 indicates that artwork 409 is animated to appear to emerge and enlarge from the image of placed product 403.

An advertising insertion as illustrated in FIG. 4A and 4B is highly effective as a pre-roll, mid-roll, and post-roll, because the effect of seeing the product placement in the video presentation is enhanced, and viewers will be more aware of the product placement. The addition of appropriate text can actively increase the level of interest in the product (e.g., “spot the product in the video . . . ”). In the case of a pre-roll, viewers will anticipate the product placement and pay more attention when the placement appears. In a mid-roll, it will renew their attention to the product placement. And in a post-roll, it will remind them of the product placement and keep the brand in their minds.

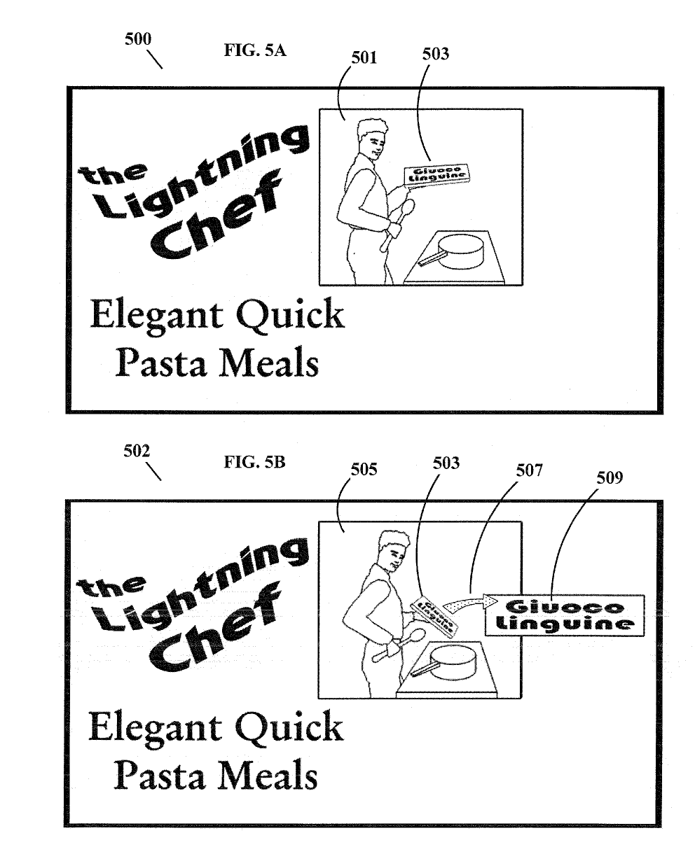

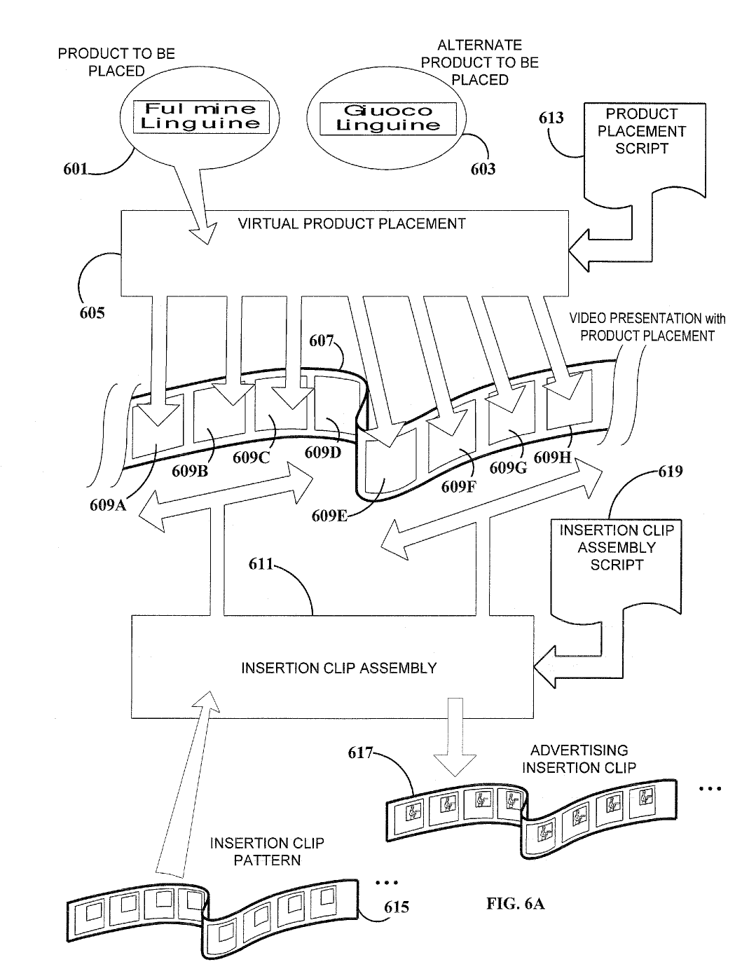

FIG. 5A of an insertion frame 500 parallels insertion frame 400 (FIG. 4A), but with a frame image 501 featuring an alternate placed product 503 injected during a repurposing procedure. An advantage of the present invention is that insertion frame 500 can be generated automatically without requiring a separate production process (as discussed below).

Likewise, FIG. 5B shows a frame 502 of the insertion clip subsequent to frame 500 (FIG. 5A), having a frame image 505 from the video presentation with placed product 503 in image container 307 instead of frame image 401. Placed product 503 may appear visually different. In addition placed product artwork 509 also appears in a reference container, with a visual effect 507. That is, placed product artwork 509 is used as a reference to the placed product in the video presentation. The arrow of visual effect 507 indicates that artwork 509 is animated to appear to emerge and enlarge from the image of placed product 503.

### Production of Insertion Clips

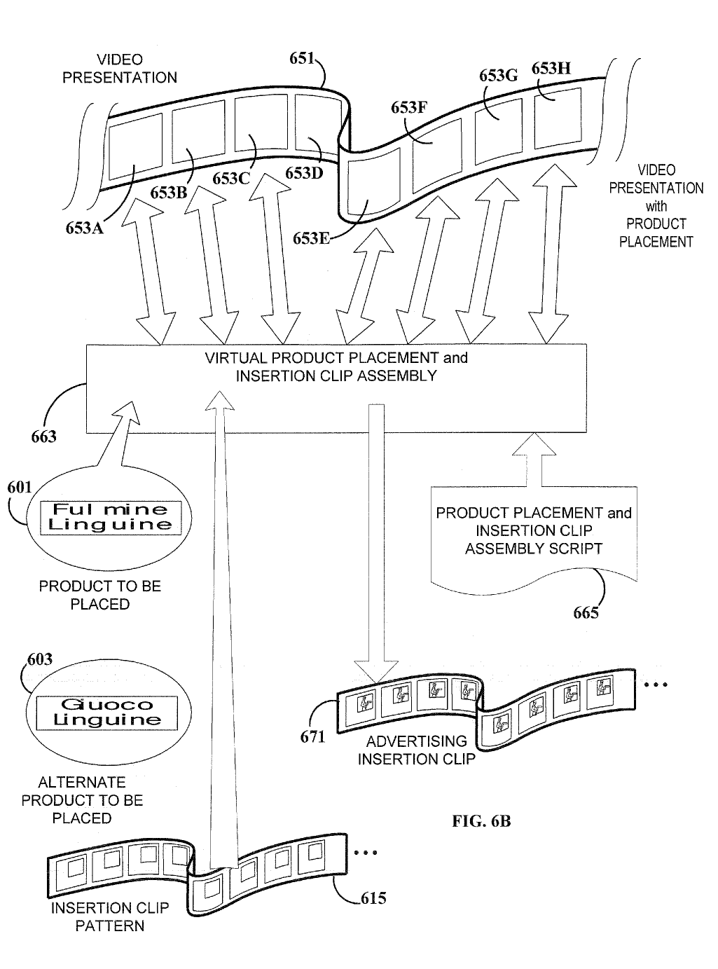

FIG. 6A conceptually illustrates a production layout for insertion clips according to an embodiment of the present invention, wherein the production of the insertion clips is an adjunct to the production of a video presentation with product placement.

Artwork 601 for a product to be placed is input to a virtual product placement process 605. Artwork 603 for an alternate product to be placed is shown to be available for subsequent repurposing. In an embodiment of the present invention, virtual product placement process 605 is automated by the use of a product placement script 613 which contains data processing commands and instructions, particularly relating to image processing and video production. The term “script” herein denotes a machine-readable document written in a scripting language, and which is intelligible to those familiar therewith. Scripting languages based on the Extensible Markup Language (“XML”) are known in the art and may be configured to be suitable for this embodiment of the present invention. It is also well-known that alternative specifications for a process can be prepared which are equivalent to a script, and therefore the use of product placement script 613 in the present capacity is non-limiting.

In virtual product placement 605, artwork 601 is injected into a recorded video presentation 607. In general, frames 609A, 609B, 609C, 609D, 609E, 609F, 609G, and 609H are injected with different aspects of artwork 601. In FIG. 6A, in a non-limiting example, frame 609D is not injected with any artwork. In the other frames, artwork 601 is suitably altered by data processing operations to accommodate the changing position, size, aspect, etc., of the container into which the artwork is injected. Methods for doing so, and for utilizing containers and placing images therein are known in the art, and are also disclosed in U.S. Provisional Patent Application 60/942,212 of the present inventor, filed Jun. 6, 2007, which is incorporated by reference herein.

In any case, it is necessary to select and identify the frames for product placement. Identification of frames can be done by placing data in the frames, such as a container; by inserting an appropriate container in the frames for receiving place products; and/or by setting attributes or parameters in frame metadata. Identification of a sequence of frames (herein denoted as a “segment”), as well as a region within a single frame or set of frames (with an arbitrary region size and shape, down to the pixel level) can also be done via the use of metadata.

In an adjunct insertion clip assembly process 611, selected frames—herein illustrated in a non-limiting example as frames 609A, 609B, 609C, 609E, 609F, 609G, and 609H (omitting frame 609D, which does not feature virtual product placement)—are injected into an insertion clip pattern 615 (discussed below) to produce an advertising insertion clip 617 according to an insertion clip assembly script 619. The foregoing comments regarding scripts and scripting language apply in this case also, so the use of assembly script 619 is non-limiting. In particular, in another embodiment of the present invention, an insertion script schedule is utilized in place of assembly script 619 (also discussed below).

Similar to the situation discussed previously regarding templates, it is noted that in practice, a data copy of a video presentation is typically made, and it is the copy which is modified by the product placement. The original video presentation itself typically remains unmodified. This is the case not only when the video presentation is stored on media for future playback, but may also apply when the video presentation is transmitted live, and the transmission stream is split into live “copies” of the “original” stream. Therefore, it is understood that references herein to video presentations for modification are intended to also relate to copies of the video presentations.

FIG. 6B conceptually illustrates a production layout for insertion clips according to another embodiment of the present invention, wherein the production of the insertion clips is integrated into the production of a video presentation with product placement. The arrangement illustrated in FIG. 6B is functionally equivalent to that illustrated in FIG. 6A.

In FIG. 6B, a virtual product placement and insertion clip assembly process 663 takes a video presentation 651 and injects artwork 601 into frames 653A, 653B, 653C, 653E, 653F, 653G, and 653H (omitting frame 653D, which does not feature virtual product placement) according to a product placement and insertion clip assembly script 665. At the same time, these frames are also injected into insertion clip pattern 615 to produce an advertising insertion clip 671.

The featured embodiments of the present invention integrate the two production efforts for the video presentation with product placement and the insertion clip referencing the product placement in the video presentation, and thereby achieve economy by preventing wasteful duplication of effort. In embodiments illustrated in FIG. 6A and in FIG. 6B, both a video presentation featuring product placement, and an advertising insertion clip referencing the video presentation and the placed product are produced from a combined process.

### Insertion Clip Patterns

Insertion clip pattern 615 has been referenced in FIG. 6A and FIG. 6B as a basis for assembling insertion clips 617 and 671 respectively. According to embodiments of the present invention, an insertion clip pattern is a video clip containing at least one product placement reference template into which a placed product from a video presentation is injected. The insertion clip pattern is a model from which an insertion clip is produced according to embodiments of the present invention, such that the insertion clip contains references to the placed product in the context of the video presentation.

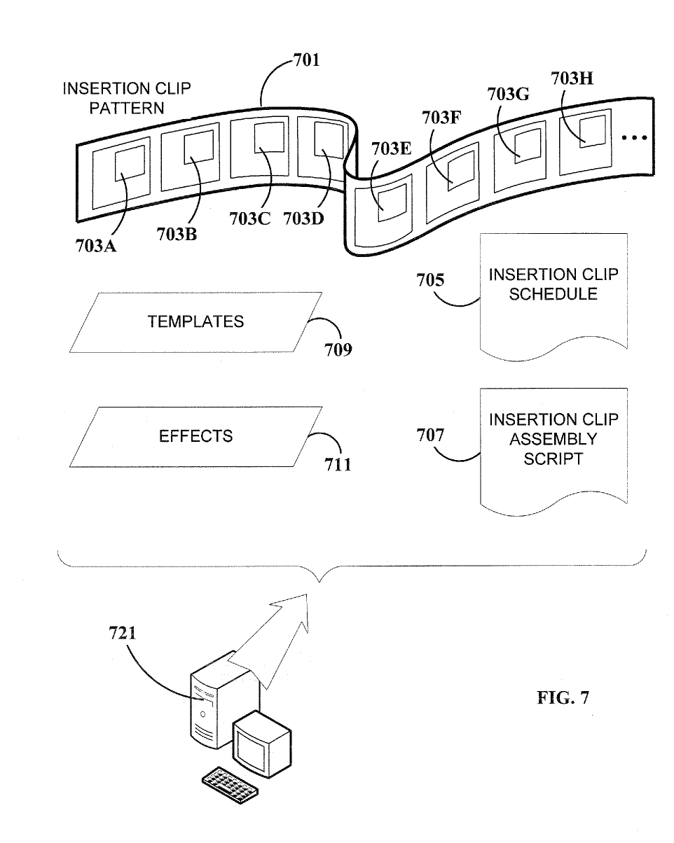

FIG. 7 illustrates an insertion clip pattern 701 with template-holding frames 703A, 703B, 703C, 703D, 703E, 703F, 703G, 703H, and possibly others (as indicated by the ellipsis . . . ).

Insertion pattern 701 can be embodied in various forms and formats, including data structures specifying templates 709 and effects data 711. The process of injecting selected video frames into the image containers of the templates and references into the reference containers of the templates can be specified by an insertion clip assembly script 707 and/or by an insertion clip schedule 705. According to an embodiment of the present invention, an insertion clip schedule is a data structure with the contents of the template containers as a function of location in the insertion clip pattern, such as by frame number. In certain cases, an insertion clip schedule would be simpler to use, but would not necessarily have the flexibility that an insertion clip assembly script might have. The two data structures do not necessarily convey precisely the same information, and in an embodiment of the present invention, the two are used together for optimal compactness and flexibility.

An insertion pattern can exist and be manipulated in display format (as is represented in FIG. 7 via insertion clip pattern 701) with associated metadata, or strictly as data by data processing equipment and computer programs therefor.

It is noted that in practice, a data copy of an insertion clip pattern is typically made, and it is the copy which is modified by the insertion of the actual data. The original insertion clip pattern itself remains unmodified for future use. Therefore, it is understood that references herein to insertion clip patterns are intended to also relate to copies thereof.

Insertion clip patterns may be created via a computer or workstation 721, and can be created and/or modified by editing as part of the production processes described herein.

Method for Producing a Video Presentation featuring a Product Placement Along With an Insertion Clip

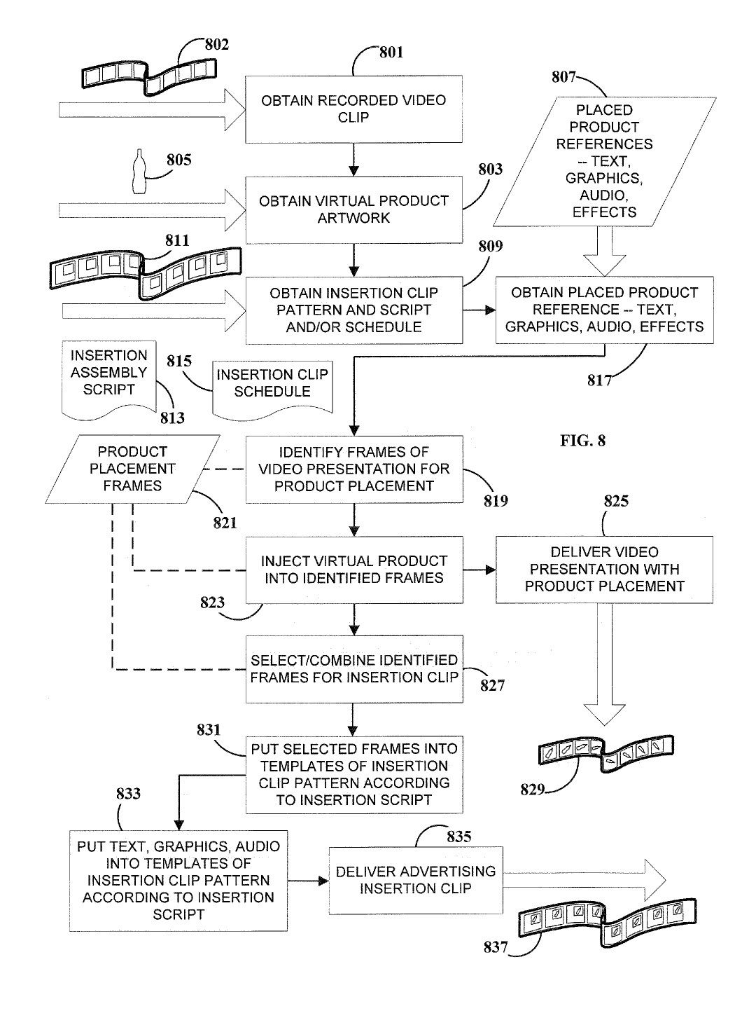

FIG. 8 is a flowchart of a method according to an embodiment of the present invention, whereby a video presentation featuring a product placement is produced along with an advertising insertion clip that references the product placement in the context of the video presentation.

In a step 801 a recorded video clip 802 for the video presentation is obtained. It is noted that recorded video clip 802 may be either stored on storage media for future playback, or may be a transmission or feed of video content that is being recorded live. In a step 803 virtual product artwork 805 is obtained. It is noted that virtual product artwork 805 may be pre-existing virtual artwork stored locally, or may be obtained from an artwork provider on an as-needed basis. In a step 809 an insertion clip pattern 811 is obtained along with an insertion assembly script 813 and/or an insertion clip schedule 815. It is noted that insertion clip pattern 811 and/or assembly script 813, and/or insertion clip schedule 815 may be pre-existing in storage, or may be obtained on an as-needed basis from outside sources. In addition, one or more of these may be generated and/or edited during the video presentation/insertion clip production process according to this method. It is noted that steps 801, 803, and 809 may be done simultaneously, or in any convenient order. In a step 817, placed product references 807 are obtained, such as text, graphics, audio, effects, and so forth as previously described. It is noted that placed product references 807 may depend on the data requirements of insertion clip pattern 811 and the templates therein.

Then, in a step 819, the frames in the video presentation which are to feature product placement are identified as product placement frames 821. The manner in which frames are identified has been previously discussed. Following this, the virtual product (artwork 805) is injected into selected product placement frames 821 in a step 823 to produce a video presentation 829 featuring product placement, which is delivered in a step 825.

Next, in a step 827 product placement frames 821 (with placed product artwork 805 injected thereinto) are selected and combined for the insertion clip, and in a step 831, these are injected into the templates of insertion clip pattern 811 according to insertion assembly script 813. Then in a step 833, placed product references 807 are injected into the templates of insertion clip pattern 811 to produce an insertion clip 837, which is delivered in a step 835.

### Method for Dynamically Producing an Insertion Clip Referencing a Pre-Existing Video Presentation Featuring a Product Placement

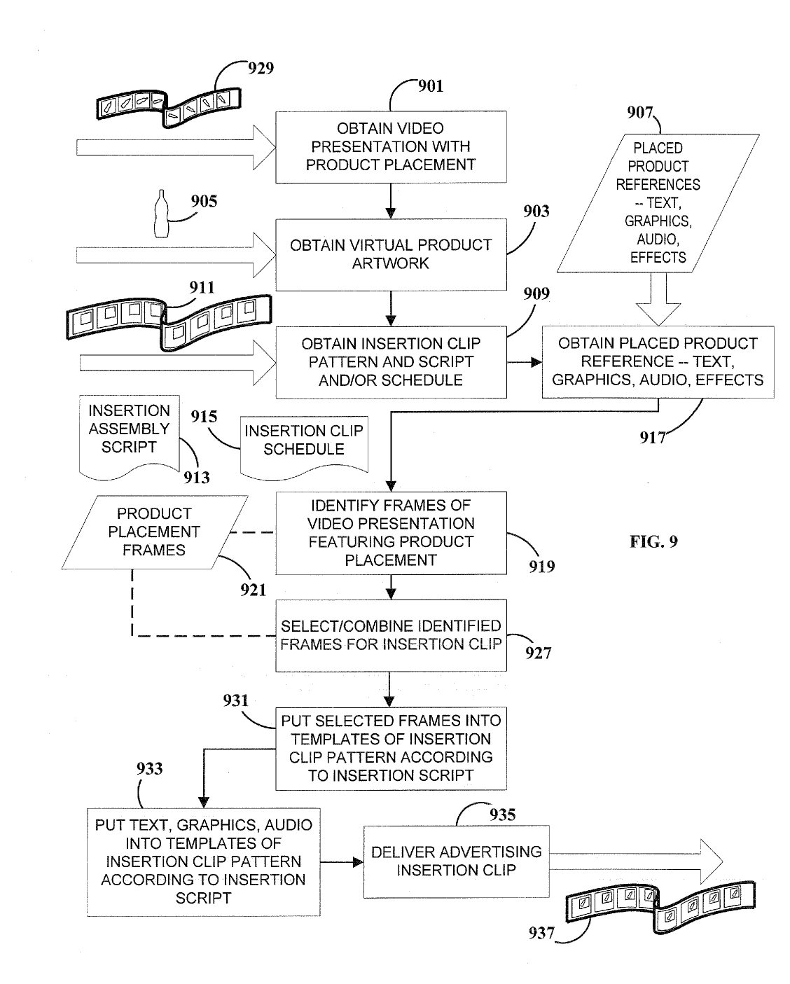

FIG. 9 is a flowchart of a method according to an embodiment of the present invention for producing an insertion clip that references a pre-existing video presentation featuring a product placement.

In a step 901 a pre-existing video presentation 929 is obtained. It is noted that pre-existing video presentation 929 may be either stored on storage media for future playback, or may be a transmission or feed of video content that was recorded live and processed for product placement in real-time. In a step 903 virtual product artwork 905 is obtained. It is noted that virtual product artwork 905 may be pre-existing virtual artwork stored locally, or may be obtained from an artwork provider on an as-needed basis. In a step 909 an insertion clip pattern 911 is obtained along with an insertion assembly script 913 and/or an insertion clip schedule 915. It is noted that insertion clip pattern 911 and/or assembly script 913, and/or insertion clip schedule 915 may be pre-existing in storage, or may be obtained on an as-needed basis from outside sources. In addition, one or more of these may be generated and/or edited during the insertion clip production process according to this method. It is noted that steps 901, 903, and 909 may be done simultaneously, or in any convenient order. In a step 917, placed product references 907 are obtained, such as text, graphics, audio, effects, and so forth as previously described. It is noted that placed product references 907 may depend on the data requirements of insertion clip pattern 911 and the templates therein.

In a step 919, the frames of video presentation 929 featuring product placement are identified as product placement frames 921.

Next, in a step 927 product placement frames 921 (with placed product artwork 905 injected thereinto) are selected and combined for the insertion clip, and in a step 931, these are injected into the templates of insertion clip pattern 911 according to insertion assembly script 913. Then in a step 933, placed product references 907 are injected into the templates of insertion clip pattern 911 to produce an insertion clip 937, which is delivered in a step 935.

A further embodiment of the present invention provides a computer program product for performing the foregoing methods or any variant derived therefrom. The term “computer program product” herein denotes a set of executable commands for a computer, which is incorporated within machine-readable media including, but not limited to: magnetic media; optical media; computer memory; semiconductor memory storage; flash memory storage; and a computer network. The terms “perform”, “performing”, etc., when used with reference to a computer program product herein denote the action of a computer when executing the computer program product, as if the computer program product were performing the actions. The term “computer” herein denotes any data processing apparatus capable of executing, and/or configured to execute the set of executable commands to perform the foregoing methods, including, but not limited to: computers; workstations; servers; gateways; routers; switches; networks; processors; and controllers.

While the present invention has been described with respect to a limited number of embodiments, it will be appreciated that many variations, modifications and other applications of the invention may be made.

What is claimed is:

1. A method for producing a video presentation featuring a placed product and an insertion clip featuring a reference to the placed product, the method comprising:
obtaining a recorded video clip for the video presentation, wherein said recorded video clip includes a plurality of recorded video frames;
obtaining virtual product artwork for a product placement;
obtaining a placed product reference to the placed product;
obtaining an insertion clip pattern for the insertion clip, wherein said insertion clip pattern contains at least one product placement reference template, wherein said product placement reference template contains:
at least one placed product video frame container for holding a video presentation frame featuring said product placement, and
at least one placed product reference container for holding said placed product reference;
identifying at least one frame of said plurality of recorded video frames in said recorded video clip for featuring said product placement;
injecting said virtual product artwork into said at least one recorded video frame, to produce the video presentation featuring said product placement;
selecting at least one frame of the video presentation featuring said product placement for the insertion clip; and
injecting said at least one frame of the video presentation featuring said product placement into said placed product video frame container of said at least one product placement reference template in said insertion clip pattern; and
injecting said placed product reference into said placed product reference container of said at least one product placement reference template in said insertion clip pattern.

2. A computer program product configured to perform the method of claim 1.

3. The method of claim 1, wherein said placed product reference includes said virtual product artwork.

4. The method of claim 1, further comprising producing at least one selected from the group consisting of: said insertion clip pattern; and said product placement reference template.

5. The method of claim 1, wherein said placed product reference includes at least one selected from the group consisting of: a text element; a graphic element; an animation; an audio element; a video effect; and an audio effect.

6. The method of claim 1, wherein said injecting said virtual product artwork into said at least one frame is done according to at least one selected from the group consisting of: a product placement script; and a product placement and insertion clip assembly script.

7. A computer program product configured to perform the method of claim 6.

8. The method of claim 6, further comprising producing at least one selected from the group consisting of: said product placement script; and said product placement and insertion clip assembly script.

9. A computer program product configured to perform the method of claim 8.

10. The method of claim 1, wherein said injecting said at least one frame of the video presentation with said product placement into said placed product video frame container is done according to at least one selected from the group consisting of: an insertion clip assembly script; a product placement and insertion clip assembly script; and an insertion clip schedule.

11. A computer program product configured to perform the method of claim 10.

12. The method of claim 10, further comprising producing at least one selected from the group consisting of: said insertion clip assembly script; said product placement and insertion clip assembly script; and said insertion clip schedule.

13. A computer program product configured to perform the method of claim 12.

14. A method for producing an insertion clip featuring a reference to a placed product from a video presentation featuring a placed product, the method comprising:
obtaining the video presentation featuring the placed product, wherein said video presentation includes a plurality of video presentation frames;
obtaining a placed product reference to the placed product;
obtaining an insertion clip pattern for the insertion clip, wherein said insertion clip pattern contains at least one product placement reference template, wherein said product placement reference template contains:
at least one placed product video frame container for holding a video presentation frame featuring said product placement; and
at least one placed product reference container for holding said placed product reference;
identifying at least one frame of said plurality of video presentation frames, wherein said at least one frame features said product placement;
injecting said at least one frame of the video presentation featuring said product placement into said placed product video frame container of said at least one product placement reference template in said insertion clip pattern; and
injecting said placed product reference into said placed product reference container of said at least one product placement reference template in said insertion clip pattern.

15. A computer program product configured to perform the method of claim 14.

16. The method of claim 14, further comprising obtaining virtual product artwork for a product placement, wherein said placed product reference includes said virtual product artwork.

17. A computer program product configured to perform the method of claim 16.

18. The method of claim 14, further comprising producing at least one selected from the group consisting of: said insertion clip pattern; and said product placement reference template.

19. A computer program product configured to perform the method of claim 18.

20. The method of claim 14, wherein said placed product reference includes at least one selected from the group consisting of: a text element; a graphic element; an animation; an audio element; a video effect; and an audio effect.
